(19) United States
(12) Patent Application Publication
(10) Pub. No.: US 2010/0149729 A1
(43) Pub. Date: Jun. 17, 2010

(54) SOLID ELECTROLYTIC CAPACITOR AND METHOD FOR MANUFACTURING THE SAME

(75) Inventor: Masaaki Nishioka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/159,732

(22) PCT Filed: Dec. 28, 2006
(86) PCT No.: PCT/JP2006/326192

§ 371 Date: Oct. 28, 2009

Related U.S. Application Data
(60) Provisional application No. 60/755,089, filed on Jan. 3, 2006.

(30) Foreign Application Priority Data
Dec. 28, 2005 (JP) 2005-376737

(51) Int. Cl. H01G 9/045; H01G 9/042; H01G 9/025

(52) U.S. Cl. 361/525; 361/528; 361/529; 29/25.03

(57) ABSTRACT

A solid electrolyte capacitor comprising an anode with a valve action composed of a metal material or a conductive oxide and having a dielectric layer, a solid electrolyte and a conductive layer, formed in this order on the surface thereof, characterized in that said conductive layer comprises conductive powders which have a particle diameter distribution wherein at least two peaks of particle diameter are present, and the minimum peak particle diameter thereof is in the range of larger than 100 nm but not larger than 1 μm. The conductive powder preferably has at least one peak having a particle size 8 to 75 times the minimum peak of particle size. The solid electrolyte capacitor has very low equivalent series resistance (ESR).

### CROSS-REFERENCE TO RELATED APPLICATION

This application was filed pursuant to 35 U.S.C. 111(a) with claiming the benefit of filing date of U.S. Provisional Application Ser. No. 60/755,089 filed Jan. 3, 2006 under the provision of 35 U.S.C. 111(b) pursuant to 35 U.S.C. 119(e) (1).

### TECHNICAL FIELD

This invention relates to a solid electrolyte capacitor, especially a solid electrolyte capacitor having a sufficiently reduced equivalent series resistance (ESR).

To cope with the demands for higher speed processing of personal computers and other electronic appliances utilizing a high frequency in recent years, the capacitors used therefor are required to have a low equivalent series resistance (ESR) in a high frequency region.

A solid electrolytic capacitor is made by a process wherein a dielectric layer is formed on a surface of an anode comprised of a metal substrate with a valve action or a conductive oxide, a semiconductor layer is formed on the dielectric layer, and then, a conductive layer is formed on the semiconductor layer to give a solid electrolyte capacitor element, and finally a plurality of the sold electrolyte capacitor elements are encapsulated with an outer encapsulating material. The anode is comprised of a metal foil or conductive oxide foil having a surface layer which is full of fine pores or voids, or a sintered body formed from a metal powder or conductive oxide powder and having fine pores or voids inside the body. At the step of forming a dielectric layer on the surface of the anode, the dielectric layer is formed also on the wall surfaces defining the fine pores or voids. At the step of forming a semiconductor layer on the dielectric layer, the semiconductor layer is also formed on the dielectric layer on the wall surfaces defining the fine pores or voids. By adopting an organic or inorganic semiconductor material having a high conductivity as the semiconductor layer, a solid electrolyte capacitor having a low ESR can be obtained.

It is known that a conductive material such as manganese dioxide is coated on a dielectric layer to form a cathode layer. However, manganese dioxide has a low conductivity, and therefore, it has been proposed to use a conductive polymeric material such as polypyrrole or polythiophene as an electrolyte for a solid electrolyte capacitor.

It also has been proposed to improve a conductive paste used for forming a conductive layer of a solid electrolyte capacitor, so as to give a solid electrolyte capacitor having a low ESR. For example, patent document 1 discloses formation of a conductive layer with a thickness of 0.01-5 μm on an electrolyte layer from a paste containing fine metal particles having a particle diameter of 10-500 angstrom. Patent document 2 discloses formation of a metal layer on a dielectric layer from a paste containing fine metal particles having an average particle diameter of not larger than 0.05 μm. Patent document 3 discloses formation of a silver layer on a solid electrolyte layer from a paste containing silver powder having an average particle diameter of 0.2-20 μm, a fine silver powder having an average particle diameter of 1-100 nm, and a binder.

Patent document 1: Japanese Unexamined Patent Publication H11-135377

Patent document 2: Japanese Unexamined Patent Publication 2004-319971

Patent document 3: Japanese Unexamined Patent Publication 2005-93741

### DISCLOSURE OF THE INVENTION

### Problems to Be Solved by the Invention

Proposals have been made to provide a solid electrolyte capacitor having a low ESR as described in patent documents 1, 2 and 3. However, further reduction of ESR is still desired.

Problems arise due to adoption of fine metal particles, for example, those having a particle diameter of 10-500 angstrom as disclosed in patent document 1 or those having a particle diameter of not larger than 0.05 μm as disclosed in patent document 2. That is, a conductive layer formed from fine metal particles has cracks of a minute size, which prevents or reduces a contact among the fine metal particles. Further, it is still difficult to reduce the ESR to the desired low level by using a mixture containing silver powder having an average particle diameter of 0.2 μm to 20 μm or a fine silver powder having an average particle diameter of 1 nm to 100 nm as disclosed in patent document 3.

In view of the foregoing, a primary object of the present invention is to provide a solid electrolyte capacitor having a sufficiently reduced ESR.

### Means for Solving the Problems

With an extensive research to solve the above-mentioned problems, the inventor found that a solid electrolyte capacitor having a sufficiently reduced ESR can be obtained by forming a conductive layer from a conductive powder having a specific particle diameter.

That is, as the results of research on the particle diameter of a conductive powder, the inventor found that an extremely fine conductive powder having nano-scale particle diameter is effective for enhancing the contact among the conductive powder particles. The inventor further found that, when the particle diameter of conductive powder particles is too small, the contact among the conductive powder particles is rather reduced. More specifically it was found that ESR can be effectively reduced to the desired level by using a conductive powder having a particle diameter distribution such that at least two peaks of particle diameter are present, wherein the minimum peak particle diameter thereof is larger than 100 nm but not larger than 1 μm. The reason for the effectiveness of the above-specified conductive powder is not clear, but it is presumed that the reduction of ESR is influenced by the surface energy change occurring due to a fine conductive powder having an extra-ordinarily reduced particle diameter, and further, by a binder although to a minor extent.

Further, it was found that ESR can be effectively reduced to the desired level by using a conductive powder having a particle diameter distribution such that at least two peaks of particle diameter are present wherein at least one peak thereof has a peak particle diameter 8 to 75 times of the minimum peak particle diameter. It is presumed that the conductive powder having such particle diameter distribution enables enhancement of packing density, which leads to a further reduction of ESR.

Thus, in accordance with the present invention, the following solid electrolytic capacitors are provided.

(1) A solid electrolyte capacitor comprising an anode composed of a metal material with a valve action or conductive oxide, and having a dielectric layer, a solid electrolyte layer and a conductive layer, formed in this order on the surface of the anode, characterized in that said conductive layer comprises conductive powders which have a particle diameter distribution wherein at least two peaks of particle diameter are present, and the minimum peak particle diameter thereof is in the range of larger than 100 nm but not larger than 1 μm.

(2) The solid electrolyte capacitor as described above in (1), wherein two or three peaks of particle diameter are present in the particle diameter distribution.

(3) The solid electrolyte capacitor as described above in (1) or (2), wherein the conductive powders have a particle diameter distribution wherein the minimum peak particle diameter is in the range of larger than 100 nm but not larger than 500 nm.

(4) The solid electrolyte capacitor as described above in any one of (1) to (3), wherein at least one peak of particle diameter is present in the particle diameter distribution, which peak has a peak particle diameter 8 to 75 times of the minimum peak particle diameter.

(5) The solid electrolyte capacitor as described above in any one of (1) to (4), wherein the metal material with a valve action is a material selected from the group consisting of aluminum, tantalum, niobium, titanium, zirconium and alloys of these metals.

(6) The solid electrolyte capacitor as described above in any one of (1) to (5), wherein the conductive powders comprise at least one kind of powder selected from powders of silver, copper, aluminum, nickel, a copper-nickel alloy, a silver alloy, and a mixed powder comprising a silver powder, and a powder coated with silver.

(7) The solid electrolyte capacitor as described above in any one of (1) to (6), wherein the conductive layer has a thickness in the range of 5 μm to 100 μm.

(8) The solid electrolyte capacitor as described above in any one of (1) to (7), wherein the solid electrolyte layer is comprised of a solid polymer electrolyte comprising at least one kind of repeating units derived from pyrrole, thiophene, aniline or furan, or at least one kind of repeating units derived from substituted derivatives having a structure of these compounds.

(9) The solid electrolyte capacitor as described above in (8), wherein the solid polymer electrolyte comprises repeating units derived from 3,4-ethylenedioxithiophene.

(10) The solid electrolyte capacitor as described above in (8) or (9), wherein the solid polymer electrolyte has incorporated therein an arylsulfonate as a dopant.

(11) A process for producing a solid electrolyte capacitor comprising the steps of forming a solid electrolyte layer on a dielectric layer formed on the surface of a metal substrate with a valve action, and then, forming a conductive layer on the solid electrolyte layer, characterized in that said conductive layer is formed from a conductive paste comprising a mixture of at least two kinds of conductive powders having different peak particle diameters wherein the minimum peak particle diameter is larger than 100 nm but not larger than 1 μm.

(12) The process for producing a solid electrolyte capacitor as described above in (11), wherein the conductive powders comprise at least one kind of powder selected from powders of silver, copper, aluminum, nickel, a copper-nickel alloy, a silver alloy, and a mixed powder comprising a silver powder, and a powder coated with silver.

(13) The process for producing a solid electrolyte capacitor as described above in (11) or (12), wherein said mixture of conductive powders comprises two or three kinds of conductive powders having different peak particle diameters.

(14) The process for producing a solid electrolyte capacitor as described above in any one of (11) to (13), wherein the minimum peak particle diameter in said mixture of conductive powders is in the range of larger than 100 nm but not larger than 500 nm.

(15) The process for producing a solid electrolyte capacitor as described above in any one of (11) to (14), wherein said mixture of conductive powders has at least one peak particle diameter 8 to 75 times of the minimum peak particle diameter.

### Effect of the Invention

The solid electrolyte capacitor according to the present invention has a sufficiently reduced ESR.

### BRIEF DESCRIPTION OF THE DRAWINGS

FIG. 1 is a schematic sectional view of a solid electrolyte capacitor element.

FIG. 2 is a schematic sectional view of an assembly comprised of stacked solid electrolyte capacitor elements.

### EXPLANATION OF REFERENCE NUMERALS

1 Anode substrate

2 Dielectric film layer

3 Solid electrolyte layer

4 Conductive material layer

5 Insulating layer

6 Solid electrolytic capacitor element

7 Anode lead

8 Cathode lead

9 Epoxy resin encapsulating material

### BEST MODE FOR CARRYING OUT THE INVENTION

The invention will now be described in detail.

(Metal with Valve Action)

The substrate of the solid electrolytic capacitor is comprised of a metal material having a valve action, which has a dielectric oxide film on the surface thereof.

The metal material with a valve action is selected from metals such as, for example, aluminum, tantalum, niobium, titanium, zirconium and alloys based on at least one of these metals. The metal material with a valve action can be used in the form of, for example, a foil or a rod, or a sintered body predominantly comprising these metals and alloys.

The metal substrate has a dielectric oxide film, formed by oxidation due to oxygen in the air, on the surface thereof. However, it is preferable the surface of a metal substrate with a valve action is roughened by a known procedure, for example, an etching procedure, and then, the metal substrate is subjected to a chemical formation to form a dielectric oxide film on the surface thereof.

As the metal substrate with a valve action, an aluminum foil having an aluminum oxide layer on the surface thereof is preferably used. After the metal substrate is subjected to a surface-roughening, it is preferably cut into a desired size and shape conforming to those of the solid electrolytic capacitor, prior to the formation of a solid electrolyte layer.

The size of the metal substrate with a valve action varies depending upon the particular use thereof. For example, when the metal substrate is of a foil form, foils having a thickness in the range of approximately 40 to 150 μm are generally used. The shape of the metal substrate with a valve action also varies depending upon the particular use thereof. For example, when the metal substrate is used for a flat sheet-shape capacitor element, a rectangular sheet having a width in the range of approximately 1 to 50 mm and a length in the range of approximately 1 to 50 mm is preferably used. More preferably the width is in the range of approximately 2 to 20 mm, especially approximately 2 to 5 mm, and the length is in the range of approximately 2 to 20 mm, especially approximately 2 to 6 mm.

(Chemical Formation)

Chemical formation of the metal substrate with a valve action, cut into the desired shape and size, can be carried out by various methods. By previously conducting the chemical formation, an increase of leak current can be prevented or minimized even in the case when faults occur in a masking layer.

The conditions under which the chemical formation is carried out are not particularly limited, but the chemical formation can be carried out under the following conditions. For example, an electrolyte solution containing at least one acid selected from oxalic acid, adipic acid, boric acid and phosphoric acid at a concentration of 0.05% to 20% by mass is used. The chemical formation is carried out at a temperature in the range of 0° C. to 90° C., and a current density in the range of 0.1 to 200 mA/cm² for a time within 60 minutes. The voltage applied is chosen depending upon the voltage applied for the formation of metal oxide layer already formed on the surface of metal substrate. More preferably the chemical formation ii carried out using the above-mentioned an electrolyte solution at a concentration of 0.1% to 15% by mass, a temperature in the range of 20° C. to 70° C., and a current density in the range of 1 mA/cm² to 100 mA/cm² for a time within 30 minutes.

The above-mentioned conditions for the chemical formation are conventionally adopted in the commercial method, but the kind and concentration of electrolyte solution, temperature, current density and formation time, and other conditions can be arbitrarily chosen provided that the dielectric oxide film formed on the surface of metal substrate is not deteriorated or destroyed.

If desired, other treatments such as, for example, a phosphoric acid immersion treatment for enhancing water resistance, and a heat treatment or boiling immersion treatment for strengthening the film can be carried out before or after the chemical formation.

The chemical formation is usually carried out after a masking layer is formed from the masking material mentioned below. But, the chemical formation can be carried out before the masking layer is formed.

(Masking Material)

A masking layer is formed for the purpose of preventing an electrolyte solution from soaking to a portion to be formed into an anode of the metal substrate, and ensuring insulation between the metal substrate and a solid electrolyte in a cathode portion to be formed in a succeeding step. The masking material used includes, for example, general heat-resistant resins, preferably heat-resistant resins which are soluble in or swellable with a solvent, and precursors thereof, and a composition comprising an inorganic fine powder and a cellulosic resin (Japanese Unexamined Patent Publication No. H11-80596), but is not particularly limited. As specific examples of the masking material, there can be mentioned polyphenylsulfone (PPS), polyethersulfone (PES), cyanic acid ester resins, fluororesins (including, for example, polytetrafluoroethylene and a tetrafluoroethylene/-fluoroalkyl-vinyl-ether copolymer), a low-molecular-weight polyimide, and derivatives thereof. Preferable masking materials include a low-molecular-weight polyimide, polyethersulfone, fluororesins and their precursors.

The step of forming a masking layer is carried out at least one time. When the step of forming a masking layer is carried out twice, a first masking layer formed in the first step has a function of preventing an electrolyte solution from soaking to a portion to be formed into an anode of the metal substrate. A first masking material used for the first masking layer is not particularly limited, but general heat-resistant resins are usually used. A second masking material used for a second masking layer formed in the second step includes heat-resistant resins which are similar to those of the first masking material, but polyimide is preferably used therefor which has a high adhesion to the metal substrate with a valve action, a good packing property and is resistant to heat treatment at a temperature up to approximately 450° C. and exhibits good insulation.

A polyimide film is usually formed by preparing a solution of polyamic acid (which is a precursor of polyimide) in a solvent, coating a metal substrate with the polyamic acid solution, and then heat-treating the coating of polyamic acid solution at a temperature sufficiently high for converting the polyamic acid to polyimide. The heat treatment for the imidation is carried out at a temperature of 250-350° C., but, this high-temperature treatment occasionally causes damages of a dielectric layer on the surface of anode film.

In the present invention, a polyimide can be used, which is capable of being sufficiently curable by heating at a relatively low temperature, specifically up to 200° C., preferably in the range of 100-200° C., and which causes only to a minimized extent damages of a dielectric layer on the surface of anode film.

Polyimide comprises an imide structure in the backbone chain. The polyimide preferably used in the present invention includes, for example, polyimide having a flexible structure in the diamine portion, which structure is easily rotatable within the molecule, and polyimide prepared by polycondensation between 3,3′,4,4′-diphenylsulfonetetracarboxylic acid dianhydride and an aromatic diamine. A preferable polyimide has an average molecular weight in the range of approximately 1,000 to 1,000,000, more preferably approximately 2,000 to 200,000.

Preferable examples of the polyimide solution, there can be mentioned a solution prepared by dissolving a low-molecular weight polyimide, which is easily curable at a heat-treatment after coating, in a solvent having a low hygroscopicity, such as, for example, 2-methoxyethylether or triethylene glycol dimethylether (said solution is commercially available as “UPICOAT™” TM-FS-100L, available from Ube Industries, Ltd.), and a solution of a polyimide in NMP (N-methyl-2-pyrrolidone) or DMAc (dimethylacetamide) (said solution is commercially available as, for example, “RIKACOAT™TM” available from New Japan Chemical Co., Ltd.).

A coating of the former solution is cured by a heat treatment at a temperature of 160° C. to 180° C. to be thereby polymerized and hardened to give a polyimide film having a flexibility, a high heat resistance and a good insulation. This polyimide film has, for example, a tensile strength of 2.0 kg/mm², an elongation (hardened film) of 65%, an initial modulus of elasticity of 40.6 kg/mm², and a maintains properties of rubbery. Further the polyimide film has, for example, a high heat resistance (i.e., heat decomposition temperature: 461° C.), a high volume resistivity of 1016 Ω·cm even at a high humidity, and a low dielectric constant of 3.2, and thus possesses good electrical properties as an insulating film.

A coating of the latter solution gives a film merely by removing the solvent at a temperature of not higher than 200° C., which film has high heat resistance, good mechanical properties, good electrical properties and high chemical resistance. More specifically the film has, for example, a tensile strength of approximately 11.8 kg/mm², an elongation (hardened film) of 14.2%, an initial modulus of elasticity of at least 274 kg/mm², a high heat resistance (i.e., 5% mass reduction temperature: 515° C.), a volume resistivity of 1016 Ω·cm, and a low dielectric constant of 3.1 at 25° C. and 2.8 at 200° C., and thus possesses good electrical properties.

Various additives can be incorporated in the above mentioned solution of masking material. As examples of the additives, there can be mentioned antifoamers such as a lower alcohol, a mineral oil, a silicone resin, oleic acid and polypropylene glycol; thixotropic agents such as finely divided silica powder, mica, talc and calcium carbonate; and resin-modifying silicone agents such as silane coupling agent, silicone oil, silicone surface active agent and synthetic silicone lubricant. For example, the incorporation of silicone oil (polysiloxane) or silane coupling agent is expected to enhance antifoaming (foaming upon curing is suppressed), release characteristics (non-sticking of conductive polymer), lubricating property (permeability into porous structure), electrical insulation (prevention of leak current), water repellency (prevention of permeation of polymerization liquid at a step of polymerization for conductive polymer), damping property (easiness in stacking of capacitor elements), and heat resistance and weather resistance of resin (curability for giving crosslinked structure). The incorporation of a composition comprising a soluble polyimide-siloxane and an epoxy resin (Japanese Unexamined Patent Publication No. H8-253677, U.S. Pat. No. 5,643,986) also gives a beneficial effect similar to that achieved by the above-mentioned incorporation of silicone oil (polysiloxane).

Method for Forming Masking Layer

The above-mentioned masking material is soluble or dispersible in an organic solvent, and is used as a solution or dispersion having a desired solid content (i.e., desired viscosity) suitable for coating. The solution or dispersion can easily be prepared. The concentration of the solution or dispersion is preferably in the range of approximately 10% to 60% by mass, more preferably approximately 15% to 40% by mass. The viscosity of the solution or dispersion is preferably in the range of approximately 50 to 30,000 cP, more preferably approximately 500 to 15,000 cP. If the concentration or viscosity is too low, the masking lines formed therefrom tend to be blurred. In contrast, if the concentration or viscosity is too high, the solution or dispersion becomes stringy and width of the masking lines is liable to be non-uniform.

The coating of the solution or dispersion of masking material can be carried out by, for example, a method described in WO00/67267.

According to the need, the masking layer formed by coating of the solution or dispersion of masking material may be subjected to a treatment such as, for example, drying, heating or irradiation with light.

(Solid Electrolyte)

No limitation is imposed to the material for the solid electrolyte used in the present invention. Solid electrolyte-forming materials conventionally used can be used. A preferable solid electrolyte material comprises a conductive polymer comprising at least one kind of repeating units derived from pyrrole, thiophene, aniline or furan, or at least one kind of repeating units derived from substituted derivatives having a structure of these compounds. Of these, a conductive polymer comprising repeating units derived from 3,4-ethylenedioxythiophene is especially preferable.

The conductive polymer layer is formed by a method wherein a solution containing a monomer such as, for example, 3,4-ethylenedioxythiophene and an oxidizing agent is coated on an oxide film layer on a metal foil substrate, followed by polymerization. Alternatively, the monomer and the oxidizing agent can be applied as separate solutions on the oxide film layer. The method for forming the conductive polymer layer is described in, for example, Japanese Unexamined Patent Publication No. H2-15611 (U.S. Pat. No. 4,910,645) and Japanese Unexamined Patent Publication No. H10-32145 (European Patent Publication 820076 A2).

The conductive polymer (i.e., solid electrolyte capacitor) usually has incorporated therein an arylsulfonate as a dopant. As specific examples of the arylsulfonate, there can be mentioned alkali metal salts and ammonium salts of benzenesulfonic acid, toluenesulfonic acid, naphthalenesulfonic acid, anthracenesulfonic acid and anthraquinonesulfonic acid. The amount of dopant is preferably in the range of 0.1 to 20% by mole based on the monomer units constituting the conductive polymer.

(Conductive Polymer Layer)

A conductive layer is formed on the solid electrolyte layer formed by the above-mentioned method, thereby giving the solid electrolyte capacitor of the present invention.

The method of forming the conductive layer includes, for example, solidification of a conductive paste such as a silver paste, a copper paste, an aluminum paste, a carbon paste and a nickel paste; plating such as nickel plating, copper plating, silver plating, aluminum plating and gold plating; vapor deposition of metal such as aluminum, nickel, copper, silver and gold; and adherence of film composed of a heat-resistant conductive resin.

The main feature of the present invention lies in that the conductive layer comprises a conductive layer comprising conductive powders, preferably conductive metal powders, which have a particle diameter distribution wherein at least two peaks of particle diameter are present, and the minimum peak particle diameter thereof is in the range of larger than 100 nm but not larger than 1 μm. The minimum peak particle diameter is preferably in the range of larger than 100 nm but not larger than 500 nm. When the peak diameter is not larger than 100 nm or larger than 1 μm, the ESR cannot be reduced to the desired magnitude.

The peak particle diameter of a conductive powder can be measured by a laser diffraction granulometer. However, the particle diameter distribution of fine particles with a sub-micron magnitude is difficult to determine because measurement error often occurs due to poor dispersibility and depending upon the particular apparatus used. Therefore, the peak particle diameter is preferably determined by analysis of photographic image of particles obtained by SEM.

The number of the peak particle diameter in the particle diameter distribution is not particularly limited provided that it is at least 2, but, said number is preferably in the range of 2 to 5, more preferably 2 or 3.

Preferably, at least one peak of particle diameter is present in the particle diameter distribution, which peak has a peak particle diameter 8 to 75 times of the minimum peak particle diameter.

The conductive powder used in the present invention includes, for example, powders of silver, copper, aluminum, nickel, a copper-nickel alloy, a silver alloy, and a mixed powder comprising a silver powder, and a powder coated with silver. More specifically the conductive powder preferably includes powders of silver, alloys predominantly comprised of silver, such as a silver-copper alloy, a silver-nickel alloy or a silver-palladium alloy; a mixed powder predominantly comprised of a silver powder, such as a silver-copper mixed powder, a silver-nickel powder, and a silver-nickel-palladium powder; and a powder coated with silver such as a silver-coated copper powder and a silver-coated nickel powder. A silver powder is especially preferable.

The conductive layer can be formed from a conductive metal paste comprising conductive metal powders satisfying the above-mentioned particle diameter distribution, or a stacked combination of the conductive metal paste with a carbon paste.

The conductive layer of the solid electrolyte capacitor usually has a very thin thickness in the range of 1 to 100 μm. To achieve the large conductivity with such thin conductive layer, the fashion is important in which the conductive powders are distributed or stacked within the conductive paste. When the conductive metal powders satisfy the above-mentioned requirement of particle diameter distribution, the desired distribution or stacking can be achieved. If the minimum peak particle diameter is not larger than 100 nm, a solid electrolyte capacitor having a sufficiently low ESR cannot be obtained.

The conductive layer preferably has a thickness of at least 5 μm, more preferably in the range of 10 to 30 μm or larger. This thickness is effective for the desired reduced ESR of a solid electrolytic capacitor. The upper limit of the thickness of conductive layer is not particularly limited, but is preferably 100 μm, more preferably 50 μm.

The conductive paste used for forming the conductive layer of the solid electrolyte capacitor of the present invention comprises a conductive powder and a resin as main ingredients. As specific examples of the resin, there can be mentioned an alkyd resin, an acrylic resin, an epoxy resin, a phenol resin, an imide resin, a fluororesin, an ester resin, an imideamide resin, an amide resin, a styrene resin and a urethane resin. Other known resins may also be used. Of these, an acrylic resin, an epoxy resin and a fluororesin are especially preferable. These resins may be used as a combination of at least two thereof.

If desired, additional ingredients other than the conductive powder and the resin, may be incorporated in the conductive paste. The additional ingredients include, for example, a solvent for dissolving the resin, a curing agent for the resin, a dispersing agent for the resin and a coupling agent including a titanium coupling agent and a silane coupling agent for the resin. In the case when the curing agent or the coupling agent is incorporated, the coated paste is hardened when it is heated at the formation of conductive layer. A solvent incorporated in the paste volatilizes when the conducive layer is finally dried in the air. If desired, a conductive polymer and metal oxide, which are used for the formation of the above-mentioned semiconductive layer, may be incorporated in the conductive paste.

The content of the conductive powder in the conductive paste is usually in the range of 40% to 97% by mass. If the amount is smaller than 40% by mass, the conductivity of the conductive paste is insufficient. In contrast, if the amount is larger than 97% by mass, the adhesion of the conductive paste is poor.

By forming the conductive layer as mentioned above, the solid electrolyte capacitor element is obtained.

The above-mentioned solid electrolyte capacitor element is encapsulated or sheathed using, for example, a resin molding, a resin case, a metal outer case, or by dipping with a resin or sheathed by laminate film, to give solid electrolyte capacitor end-products for various uses. Of these, resin molding encapsulation is preferable because a solid electrolyte capacitor having a small size can easily be obtained with a low cost.

Resin encapsulation will be specifically described.

The solid electrolyte capacitor according to the present invention is made from the above-mentioned capacitor element by the following procedures.

A lead frame having a pair of confronting end portions is prepared. The capacitor elements are placed on the lead frame in a manner such that a part of each conductive layer of the capacitor elements is superposed on one end portion of the lead frame, and a part of each anode of the capacitor elements is superposed on the other end portion of the lead frame. Note, in the case when each anode of the capacitor element has an anode lead, the anode lead is superposed on the other end portion of the lead frame. A tip portion of each anode lead provided in the capacitor element can be cut before superposition on the lead frame so that the anode lead has a predetermined length. The superposed part of each conductive layer of capacitor elements is bonded to the end portion of the lead frame, for example, by solidifying the paste constituting the conductive layer. The superposed part of each anode of capacitor elements is bonded to the other end portion of the lead frame, for example, by welding. Thus, electrical and mechanical connection is obtained.

The thus-obtained assembly of capacitor elements connected to the lead frame is encapsulated with an encapsulating resin in a manner such that end portions of the lead frame project outside the encapsulated assembly. The projecting portions of the lead frame are cut to a predetermined length, and the remaining projecting portions are folded so as to tightly contact with the outer periphery of the encapsulated assembly.

Alternatively, the assembly of capacitor elements connected to the lead frame can be encapsulated with an encapsulating resin in a manner such that the lower surface and/or side surface of the lead frame are exposed and end portions of the lead frame project outside the encapsulated assembly. In this case, the projecting portions of the lead frame can be are cut entirely.

The thus partly cut lead frame forms outer terminals of the capacitor. The shape of the lead frame is a flat foil or flat sheet-form. The material for the lead frame includes iron, copper, aluminum and alloys predominantly comprise these metals. The lead frame may be partly or wholly plated with, for example, solder, tin, titanium, gold or silver. Prior to the plating, the lead frame may be subjected to primary plating with, for example, nickel or copper.

If desired, the lead frame can be subjected to plating before or after its projecting portions are cut and folded. Alternatively, the lead frame can be subjected to plating before the lead frame is bonded to the solid electrolyte capacitor elements, and further to plating after the assembly of the capacitor elements connected to the lead frame is encapsulated with a resin.

The above-mentioned lead frame has a pair of confronting end portions with a predetermined space between the confronting end portions. Using such leading frame, insulation between the anode and the conductive layer of the solid electrolyte capacitor can be ensured.

As the resin used for encapsulation of the capacitor elements in the present invention, epoxy resins, phenol resins, alkyd resins and other resins which are conventionally used for encapsulation of capacitor elements can be used. Commercially available low-stress flexible resins can preferably used as the encapsulating resin because the occurrence of stress in the solid electrolyte capacitor at encapsulation can be minimized or mitigated. The procedure of resin encapsulation is preferably conducted using a transfer machine.

The thus-obtained solid electrolyte capacitor can be subjected to an aging treatment for recovering thermal and/or physical deterioration in the conductive layer occurring at the formation of the conductive layer or at the resin encapsulation.

The aging treatment can be conducted by imposing a predetermined voltage to the solid electrolyte capacitor. The magnitude of voltage adopted is up to two times of the rated voltage. The optimum aging time and temperature vary depending upon the kind and capacitance of capacitor, and the rated voltage, but can be easily determined by a preliminary test. Usually the aging time is in the range of several minute to several days. The aging temperature is usually not higher than 300° C. to avoid heat deterioration of a voltage-imposing apparatus. The aging treatment can be carried out in the air or a gaseous atmosphere of, for example, argon, nitrogen or helium, and under reduced pressure, atmospheric pressure or high pressure. It is occasionally preferable to conduct the aging treatment while or after water vapor is supplied because the stability of the dielectric oxide layer is liable to be enhanced. More specifically the aging treatment can be carried out by a procedure wherein water vapor is supplied and then the capacitor is left to stand at a high temperature of 150° C. to 250° C. for several minutes to several days whereby the aging is effected while excessive water is removed. A procedure can be adopted wherein the capacitor is heated in an oven for aging in which water vapor is evaporated from a vessel placed therein.

The application of voltage for aging can be effected by an apparatus designed to apply an arbitrary current such as, for example, direct current, alternating current (with a desired wave-form), pulse current or direct current-biased alternating current. The application of voltage may be conducted continuously or intermittently.

The solid electrolyte capacitor according to the present invention has a sufficiently reduced equivalent series resistance (ESR). Therefore, electronic circuits and electronic instruments, which exhibit a high-speed response can be obtained from the solid electrolytic capacitor.

The solid electrolyte capacitor according to the present invention is advantageously used for CPU, power circuits and other circuits using a capacitor with a high capacitance. These circuits can be utilized in electronic appliances and instruments such as personal computers, servers, cameras, games, DVD, AV appliances and instruments, cellular phones and other digital appliances and instruments, and power instruments.

### EXAMPLES

The invention will now be specifically described by the following typical examples that are mere illustration and by no means limit the scope of the invention.

### Examples 1-4, Comparative Examples 1-8

Approximately 0.1 g of a niobium powder was put in a hopper of a tantalum element automatic molding machine (“TAP-2R” available from SEIKEN Co., Ltd.) where the niobium powder was automatically molded together with a niobium wire with a 0.3 mm diameter into a molding having a size of 4.5 mm×3.0 mm×1.8 mm. The molding was left to stand at a temperature of 1,250° C. under a reduced pressure of 4×10⁻³ Pa for 30 minutes to give a sintered body.

30 pieces of the sintered bodies were subjected to electrochemical formation in an aqueous 0.1% phosphoric acid solution at a voltage of 20V for 200 minutes to form a dielectric oxide film on the surface of each sintered body. Then the sintered bodies were contacted with an equi-volume mixed liquid of an aqueous 10% ammonium persulfate solution and an aqueous 0.5% anthraquinonesulfonic acid and then exposed to a pyrrole vapor. This procedure of contacting with the mixed liquid and then exposing to a pyrrole vapor was repeated at least 5 times whereby a counter electrode composed of polypyrrole was formed on the dielectric oxide film of each sintered body. The polypyrrole-formed sintered bodies were washed with deionized water for 30 minutes and then dried at 105° C. for 20 minutes. Thereafter the dried sintered bodies were dipped in a carbon paste and then dried at 105° C. for 30 minutes.

The carbon paste used was a suspension in butyl acetate of a mixture of 100 parts by weight of an artificial graphite powder having an aspect ratio of 3 to 1.5 and an average particle diameter of 3 μm and containing not more than 2% by mass of particles with a particle diameter of at least 32 μm and 99% by mass of fixed carbon, with a resin binder (“Viton SVX™”, a copolymer of vinylidene fluoride, hexafluoropropylene and tetrafluoroethylene, specific gravity 1.85, available from Du Pont-Dow Elastomers Co., Ltd.).

The carbon-coated sintered bodies were in a silver paste having a composition shown in Table 1, and then dried at 80° C. for 30 minutes and further at 150° C. for 30 minutes. The dried sintered bodies were placed on a lead frame made of copper alloy whereby the sintered bodies were bonded to the lead frame by the silver paste to give an assembly of stacked solid electrolyte capacitor elements. An anode lead was bonded to the assembly of stacked solid electrolyte capacitor elements, and then the whole assembly was encapsulated with an epoxy resin (“EME-7320A” available from Sumitomo Bakelite Co., Ltd.). The encapsulated assembly was aged by applying a rated voltage at 120° C. for 3 hours. Thus 30 kinds of solid electrolyte capacitors were obtained.

The silver paste used was prepared by blending 85% by mass of a silver powder and 15% by mass of Viton to prepare a solid content for the paste, and then kneading the solid content together with butyl acetate as a solvent to give a paste having a solid content of 60% by mass. For the preparation of silver pastes having particle diameter distributions shown in Table 1, four kinds of silver powders having peak particle diameters of 0.03 μm, 0.12 μm, 1.0 μm and 9 μm were mixed at ratios shown in Table 1.

Capacitance, ESR and leak current of each solid electrolyte capacitor were evaluated. The results are shown in Table 2. The measurement of capacitance was conducted using an LCR meter available from Agilent Technologies Co., Ltd. at room temperature and 120 Hz. The measurement of ESR was conducted at room temperature and 100 kHz. The measurement of leak current was conducted after application of 2.5 V at room temperature for 30 minutes.

TABLE 1
Composition of Silver Powder in Silver Paste

| | Peak particle diameter of silver powder (μm) | | | |
|---|---|---|---|---|
| | 0.03 | 0.12 | 1.0 | 9.0 |
| Comparative Example 1 | 50 | 50 | — | — |
| Comparative Example 2 | 50 | — | 50 | — |
| Comparative Example 3 | 50 | — | — | 50 |
| Example 1 | — | 50 | 50 | — |
| Example 2 | — | 50 | — | 50 |
| Example 3 | — | — | 50 | 50 |
| Comparative Example 4 | 33 | 33 | 33 | — |
| Example 4 | — | 33 | 33 | 33 |
| Comparative Example 5 | 100 | — | — | — |
| Comparative Example 6 | — | 100 | — | — |
| Comparative Example 7 | — | — | 100 | — |
| Comparative Example 8 | — | — | — | 100 |

TABLE 2
Performance of Capacitor

| | Capacitance | ESR | LC |
|---|---|---|---|
| | (μF) | (mΩ) | (μA) |
| Comparative Example 1 | 650 | 30 | 5.7 |
| Comparative Example 2 | 640 | 30 | 5.9 |
| Comparative Example 3 | 650 | 40 | 6.5 |
| Example 1 | 650 | 20 | 7.2 |
| Example 2 | 650 | 20 | 6.7 |
| Example 3 | 640 | 22 | 6.8 |
| Comparative Example 4 | 650 | 30 | 7.3 |
| Example 4 | 650 | 20 | 6.6 |
| Comparative Example 5 | 650 | 40 | 5.5 |
| Comparative Example 6 | 640 | 25 | 5.9 |
| Comparative Example 7 | 640 | 28 | 6.9 |
| Comparative Example 8 | 640 | 45 | 5.4 |

### Examples 5-8, Comparative Examples 9-16

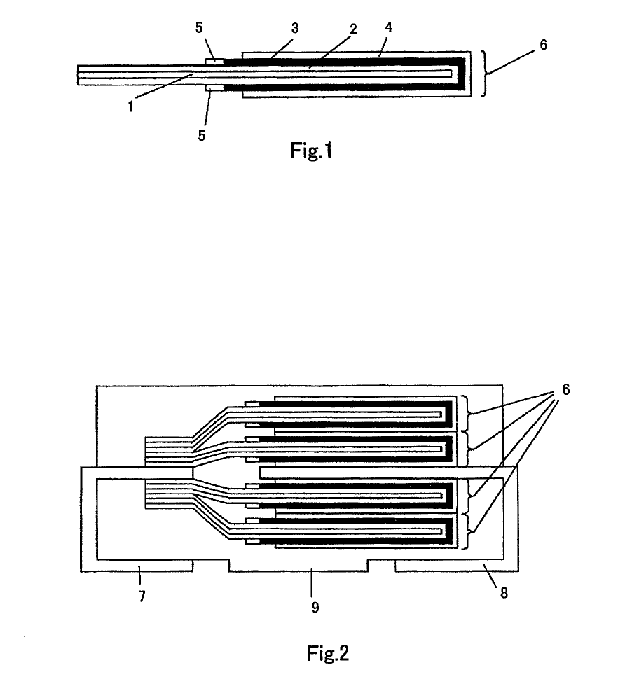

A single sheet solid electrolyte capacitor element having a structure shown in FIG. 1 was made as follows.

An etched aluminum foil [anode substrate (1)] having an alumina dielectric film formed on the surface thereof was cut into a desired size (thickness 80 μm, length 7 mm and width 3 mm). One end portion thereof having a length of 1 mm and a width of 3 mm was an anode portion. An insulating film with a width of 1 mm was wound around in a region adjacent to the anode portion of the aluminum foil, to form an insulating layer (5). The portion having a length of 4 mm and a width of 3 mm, which is other than the anode portion and the insulating layer-formed portion, was subjected to chemical formation by treating with an aqueous ammonium adipate solution having a concentration of 10% by mass at 20 V to form a dielectric film (2) on the end portion including the cut surface. The substrate was then immersed in an aqueous solution containing 15% by mass of ammonium persulfate and 0.05% by mass of sodium anthraquinone-2-sulfonate, and then further immersed in a solution in isopropanol containing 5 g of 3,4-ethylenedioxythiophene (“Baytron-M™” available from Bayer AG) with a concentration of 1.2 mol/liter. The substrate was taken and left to stand at 60° C. for 20 minutes thereby completing an oxidative polymerization. This procedure of oxidative polymerization was repeated 15 times. Then the substrate was washed with water to form a solid electrolyte layer (3) composed of a conductive polymer.

50% by mass of an artificial graphite powder and 50% by mass of “Viton SVX™” (a copolymer of vinylidene fluoride, hexafluoropropylene and tetrafluoroethylene, available from Du Pont-Dow Elastomers Co., Ltd.) were mixed together to prepare a solid content for a paste. The solid content was kneaded together with butyl acetate as a solvent to give a carbon paste having a solid content of 45% by mass.

A portion of the above-mentioned substrate, in which portion the conductive polymer layer was formed, was dipped in the carbon paste and dried to form a carbon paste layer (4) on the conductive polymer layer, which layer (4) reached the cathode-side end of the insulating layer (5).

Further the substrate was treated with a silver paste having a composition, which was the same as used in Examples 1-8 and Comparative Examples 1-4, and shown in Table 1, whereby a single sheet solid electrolyte capacitor element (6) was obtained.

Four single sheet-form solid electrolyte capacitor elements (6) were stacked and bonded together using the same silver paste, and a copper alloy cathode lead (8) and a copper alloy anode lead (7) were connected to the stacked capacitor elements using the same silver paste, in a fashion shown in FIG. 2 to give an assembly of stacked solid electrolyte capacitor elements. After the bonding of the anode lead to the assembly of stacked solid electrolyte capacitor elements, the whole assembly was encapsulated with an epoxy resin (9) (“EME-7320A” available from Sumitomo Bakelite Co., Ltd.). The encapsulated assembly was aged by applying a rated voltage at 120° C. for 3 hours. Thus 30 kinds of solid electrolyte capacitors were obtained.

Capacitance of each solid electrolyte capacitor as an initial characteristic was measured at 120 Hz. Equivalent series resistance (ESR) of each solid electrolyte capacitor was measured at 100 kHz. Leak current (LC) of each solid electrolyte capacitor was measured after applying 6.3 V for 1 minute. The results (average values) are shown in Table 3.

TABLE 3
Performance of Capacitor

| | Capacitance | ESR | LC |
|---|---|---|---|
| | (μF) | (mΩ) | (μA) |
| Comparative Example 9 | 45 | 5.9 | 5.7 |
| Comparative Example 10 | 46 | 6.0 | 5.9 |
| Comparative Example 11 | 44 | 6.6 | 6.5 |
| Example 5 | 45 | 4.1 | 7.2 |
| Example 6 | 45 | 4.0 | 6.7 |
| Example 7 | 47 | 4.2 | 6.8 |
| Comparative Example 12 | 45 | 5.8 | 7.3 |
| Example 8 | 45 | 4.0 | 6.6 |
| Comparative Example 13 | 42 | 6.5 | 5.5 |
| Comparative Example 14 | 45 | 4.3 | 5.9 |
| Comparative Example 15 | 43 | 5.5 | 6.9 |
| Comparative Example 16 | 45 | 7.0 | 5.4 |

### INDUSTRIAL APPLICABILITY

The solid electrolyte capacitor according to the present invention has a sufficiently reduced equivalent series resistance (ESR). Therefore, electronic circuits and electronic instruments, which exhibit a high-speed response can be obtained from the solid electrolytic capacitor.

The solid electrolyte capacitor according to the present invention is advantageously used for CPU, power circuits and other circuits using a capacitor with a high capacitance. These circuits can be utilized in electronic appliances and instruments such as personal computers, servers, cameras, games, DVD, AV appliances and instruments, cellular phones and other digital appliances and instruments, and power instruments.

1. A solid electrolyte capacitor comprising an anode composed of a metal material with a valve action or a conductive oxide, and having a dielectric layer, a solid electrolyte layer and a conductive layer, formed in this order on the surface of the anode, characterized in that said conductive layer comprises conductive powders which have a particle diameter distribution wherein at least two peaks of particle diameter are present, and the minimum peak particle diameter thereof is in the range of larger than 100 nm but not larger than 1 μm.

2. The solid electrolyte capacitor according to claim 1, wherein two or three peaks of particle diameter are present in the particle diameter distribution.

3. The solid electrolyte capacitor according to claim 1, wherein the conductive powders have a particle diameter distribution wherein the minimum peak particle diameter is in the range of larger than 100 nm but not larger than 500 nm.

4. The solid electrolyte capacitor according to claim 1, wherein at least one peak of particle diameter is present in the particle diameter distribution, which peak has a peak particle diameter 8 to 75 times of the minimum peak particle diameter.

5. The solid electrolyte capacitor according to claim 1, wherein the metal material with a valve action is a material selected from the group consisting of aluminum, tantalum, niobium, titanium, zirconium and alloys of these metals.

6. The solid electrolyte capacitor according to claim 1, wherein the conductive powders comprise at least one kind of powder selected from powders of silver, copper, aluminum, nickel, a copper-nickel alloy, a silver alloy, and a mixed powder comprising a silver powder, and a powder coated with silver.

7. The solid electrolyte capacitor according to claim 1, wherein the conductive layer has a thickness in the range of 5 μm to 100 μm.

8. The solid electrolyte capacitor according to claim 1, wherein the solid electrolyte layer is comprised of a solid polymer electrolyte comprising at least one kind of repeating units derived from pyrrole, thiophene, aniline or furan, or at least one kind of repeating units derived from substituted derivatives having a structure of these compounds.

9. The solid electrolyte capacitor according to claim 8, wherein the solid polymer electrolyte comprises repeating units derived from 3,4-ethylenedioxythiophene.

10. The solid electrolyte capacitor according to claim 1, wherein the solid polymer electrolyte has incorporated therein an arylsulfonate as a dopant.

11. A process for producing a solid electrolyte capacitor comprising the steps of forming a solid electrolyte layer on a dielectric layer formed on the surface of a metal substrate with a valve action, and then, forming a conductive layer on the solid electrolyte layer, characterized in that said conductive layer is formed from a conductive paste comprising a mixture of at least two kinds of conductive powders having different peak particle diameters wherein the minimum peak particle diameter is larger than 100 nm but not larger than 1 μm.

12. The process for producing a solid electrolyte capacitor according to claim 11, wherein the conductive powders comprise at least one kind of powder selected from powders of silver, copper, aluminum, nickel, a copper-nickel alloy, a silver alloy, and a mixed powder comprising a silver powder, and a powder coated with silver.

13. The process for producing a solid electrolyte capacitor according to claim 11, wherein said mixture of conductive powders comprises two or three kinds of conductive powders having different peak particle diameters.

14. The process for producing a solid electrolyte capacitor according to claim 11, wherein the minimum peak particle diameter in said mixture of conductive powders is in the range of larger than 100 nm but not larger than 500 nm.

15. The process for producing a solid electrolyte capacitor according to claim 11, wherein said mixture of conductive powders has at least one peak particle diameter 8 to 75 times of the minimum peak particle diameter.
